(19) United States
(12) Patent Application Publication
(10) Pub. No.: US 2023/0009095 A1
(43) Pub. Date: Jan. 12, 2023

(54) DATA TRANSMISSION METHOD AND APPARATUS, AND RELATED ASSEMBLY

(71) Applicant: INSPUR SUZHOU INTELLIGENT TECHNOLOGY CO., LTD., Suzhou, Jiangsu (CN)

(72) Inventors: Zhaohui WANG, Suzhou, Jiangsu (CN); Tongqiang LIU, Suzhou, Jiangsu (CN)

(21) Appl. No.: 17/785,199

(22) PCT Filed: Jul. 24, 2020
(86) PCT No.: PCT/CN2020/103999

§ 371 Date: Jun. 14, 2022

(30) Foreign Application Priority Data
Dec. 15, 2019 (CN) 201911287932.8

(51) Int. Cl. G06F 13/40; G06F 13/16

(52) U.S. Cl. CPC G06F 13/4027; G06F 13/1668

(57) ABSTRACT

A data transmission method applied to an APB bridge for connecting an APB and an AHB, includes: dividing transmission into an address phase and a data phase according to a feature of an AHB; in the address phase, when the AHB meets an address transmission condition corresponding to a current operation, transmitting address information and control information, which are sent by the AHB, to an APB; and in the data phase, when the APB meets a valid data transmission condition corresponding to the current operation, sending received data to a bus corresponding to the current operation, wherein the bus is the APB or the AHB. According to the present application, the address information, the control information, and the data do not need to be cached, whereby the occupation of a storage space is reduced. Further disclosed are a data transmission apparatus and an electronic device having the above beneficial effects.

This application claims priority to Chinese Patent Application No. 201911287932.8, filed on Dec. 15, 2019, in China National Intellectual Property Administration and entitled “Data Transmission Method and Apparatus, and Related Assembly”, the contents of which are hereby incorporated by reference in its entirety.

### FIELD

The present disclosure relates to the field of Advanced Microcontroller Bus Architecture (AMBA) buses, and particularly to a data transmission method and apparatus, and a related assembly.

### BACKGROUND

A Baseboard Management Controller (BMC) chip is integrated with a processor that communicates with an external device through a data bus. Taking an Advanced Reduced Instruction Set Computer (RISC) Machine (ARM) processor as an example, the ARM processor communicates with an external device through an AMBA bus, and according to an AMBA protocol specification, needs to transmit data on an Advanced High performance Bus (AHB) to an Advanced Peripheral Bus (APB). Conversion and transmission of data on two buses are generally implemented through a bridge.

Referring to FIGS. 1 and 2, FIG. 1 is a transmission timing diagram of the AHB, and FIG. 2 is a transmission timing diagram of the APB. It can be seen that, in an existing AHB transmission solution, for a current transaction, address information and control information are transmitted first, and then data is transmitted in a next clock cycle. The transmission of the address information and the control information needs only one clock cycle, and the transmission of the data needs multiple clock cycles. In an existing APB transmission solution, for the same transaction, the address information, the control information, and the data are transmitted at the same time. Therefore, the address information and control information sent by the AHB need to be cached in an APB bridge, and then the information and the data are transmitted after being completely received. As a result, excessive cache isolators are used, and a large storage space is occupied.

Therefore, how to provide a solution to the foregoing technical problem is a problem currently needed to be solved by those skilled in the art.

### SUMMARY

An objective of the present application is to provide a data transmission method and apparatus, and an electronic device. Address information, control information, and data do not need to be cached, whereby the occupation of a storage space is reduced.

In order to solve the foregoing technical problem, the present application provides a data transmission method, applied to an APB bridge for connecting an APB and an AHB, including:

dividing transmission into an address phase and a data phase according to a feature of the AHB;

in the address phase, in response to the AHB meeting an address transmission condition corresponding to a current operation, transmitting address information and control information, which are sent by the AHB, to the APB; and

in the data phase, in response to the APB meeting a valid data transmission condition corresponding to the current operation, sending received data to a bus corresponding to the current operation, wherein the bus is the APB or the AHB.

Preferably, after the step of dividing transmission into the address phase and the data phase according to the feature of the AHB, the data transmission method further includes:

setting a first identifier corresponding to the address phase and a second identifier corresponding to the data phase; and

judging whether a current transmission is in the address phase or the data phase according to whether the first identifier or the second identifier is valid.

Preferably, the address transmission condition includes that HTRANS of the AHB is 2′b02, and HREADY of the AHB is valid.

Preferably, the current operation includes a read operation or a write operation.

In response to the current operation being the read operation, the valid data transmission condition includes that:

levels of PREADY, PENABLE, and PSEL are all high.

In response to the current operation being the write operation, the valid data transmission condition includes that:

the level of PREADY is high.

Preferably, during the step of sending of received data to a bus corresponding to the current operation, the data transmission method further includes:

assigning a value of PREADY to HREADY.

Preferably, the data transmission method further includes:

in response to the first identifier and the second identifier being both valid, determining that the current transmission is in the address phase.

Preferably, the data transmission method further includes:

in response to HREADY and HTRANS being both valid, determining that the first identifier is valid; and

determining that the second identifier is valid in a next clock cycle after the first identifier is valid.

Preferably, the data transmission method further includes:

in response to the first identifier and the second identifier being both invalid, triggering HREADY to be converted to a high level.

In order to solve the foregoing technical problem, the present application also provides a data transmission apparatus, applied to an APB bridge for connecting an APB and an AHB, including:

a division module, configured to divide transmission into an address phase and a data phase according to a feature of the AHB;

a first transmission module, configured to, in the address phase, in response to the AHB meeting an address transmission condition corresponding to a current operation, transmit address information and control information, which are sent by the AHB, to the APB; and

a second transmission module, configured to, in the data phase, in response to the APB meeting a valid data transmission condition corresponding to the current operation, send received data to a bus corresponding to the current operation, wherein the bus is the APB or the AHB.

In order to solve the foregoing technical problem, the present application also provides an electronic device, including:

a memory, configured to store a computer program; and

a processor, configured to execute the computer program to implement any steps of the data transmission method as described above.

The present application provides a data transmission method, applied to an APB bridge for connecting an APB and an AHB. A transmission process is divided into an address phase and a data phase first according to a feature of the AHB such that address information, control information, and data are transmitted in corresponding clock cycles respectively. In the present application, received information or data is transmitted when a condition corresponding to the current phase is met, whereby time for caching the address information, the control information, and the data is reduced, and the occupation of a storage space is thus reduced. The present application also provides a data transmission apparatus and an electronic device, which have the same beneficial effects as the data transmission method.

### BRIEF DESCRIPTION OF THE DRAWINGS

In order to describe the technical solutions in embodiments of the present disclosure more clearly, the drawings required to be used in the prior art and the embodiments will be introduced briefly below. Apparently, the drawings in the description below are only some embodiments of the present disclosure. Those ordinarily skilled in the art may further obtain other drawings according to these drawings without creative work.

FIG. 1 is a transmission timing diagram of an AHB according to the present application;

FIG. 2 is a transmission timing diagram of an APB according to the present application;

FIG. 3 is a schematic structural diagram of a data transmission system according to the present application;

FIG. 4 is a flowchart of a data transmission method according to the present application;

FIG. 5 is a timing diagram of an AHB-to-APB read operation according to the present application;

FIG. 6 is a timing diagram of an AHB-to-APB write operation according to the present application;

FIG. 7 is an AHB-to-APB multi-transaction timing diagram according to the prior art;

FIG. 8 is an AHB-to-APB multi-transaction timing diagram according to the present application;

FIG. 9 is a schematic structural diagram of a data transmission apparatus according to the present application; and

FIG. 10 is a schematic structural diagram of an electronic device according to the present application.

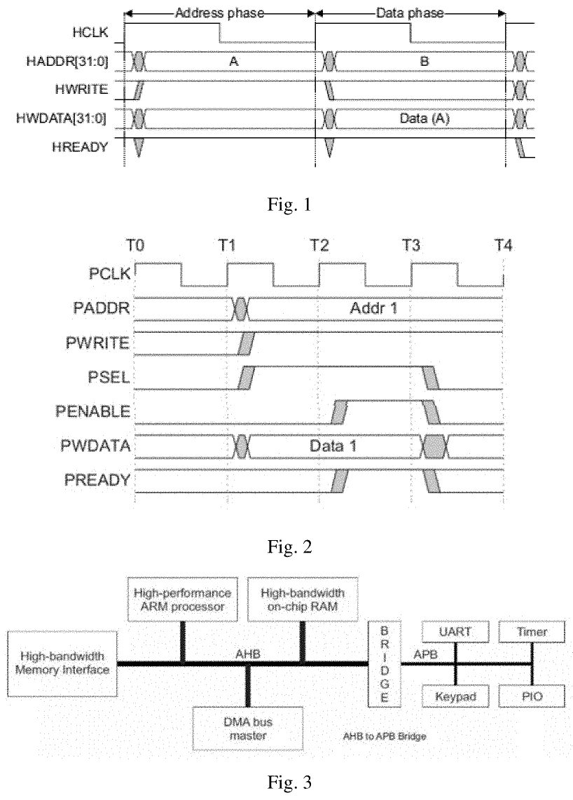

### DETAILED DESCRIPTION

The core of the present disclosure is to provide a data transmission method and apparatus, and an electronic device. Address information, control information, and data do not need to be cached, whereby the occupation of a storage space is reduced.

In order to make the objective, technical solutions, and advantages of the embodiments of the present disclosure clearer, the technical solutions in the embodiments of the present disclosure will be described clearly and completely below in combination with the drawings in the embodiments of the present disclosure. Clearly, the described embodiments are not all but only part of embodiments of the present disclosure. All other embodiments obtained by those ordinarily skilled in the art based on the embodiments in the present disclosure without creative work shall fall within the scope of protection of the present disclosure.

For ease of understanding the data transmission method of the present application, a system that the data transmission method of the present application is applicable for will be introduced below. Referring to FIG. 3, a schematic structural diagram of a data transmission system according to an embodiment of the present application is shown.

As shown in FIG. 3, a high-bandwidth memory interface, a high-performance ARM processor, a high-bandwidth on-chip Random Access Memory (RAM), and a Direct Memory Access (DMA) bus master are mounted to an AHB, and a Universal Asynchronous Receiver Transmitter (UART), a keypad, a timer, a Parts In One (PIO, a novel barebone computer that may be assembled into an integrated computer freely), and other peripherals are mounted to an APB. The AHB is connected with the APB through an AHB to APB bridge, referred to as an APB bridge hereinafter for short. The data transmission method provided in the present application may specifically be implemented by the APB bridge. The APB bridge may be considered as a slave device of the AHB and a master device of the APB.

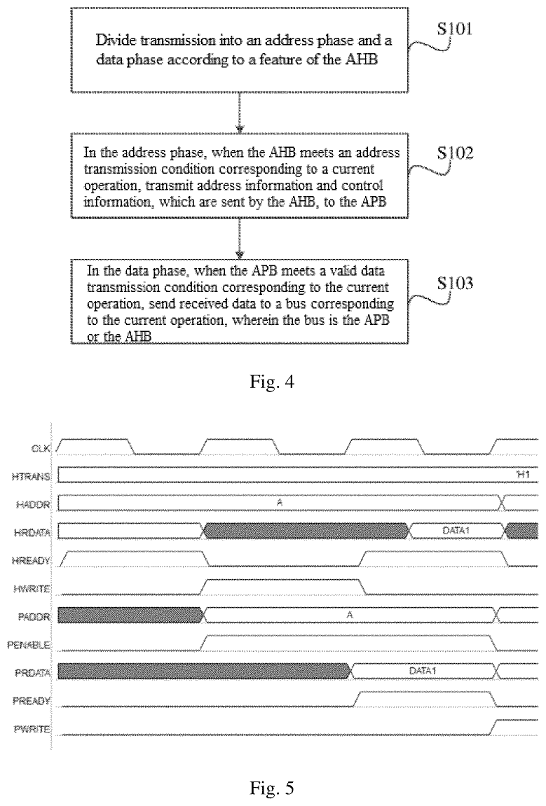

Referring to FIG. 4, FIG. 4 is a flowchart of a data transmission method according to the present application. The data transmission method includes the following steps.

In S101, transmission is divided into an address phase and a data phase according to a feature of an AHB.

In S102, in the address phase, when the AHB meets an address transmission condition corresponding to a current operation, address information and control information, which are sent by the AHB, are transmitted to an APB.

In S103, in the data phase, when the APB meets a valid data transmission condition corresponding to the current operation, received data is sent to a bus corresponding to the current operation, wherein the bus is the APB or the AHB.

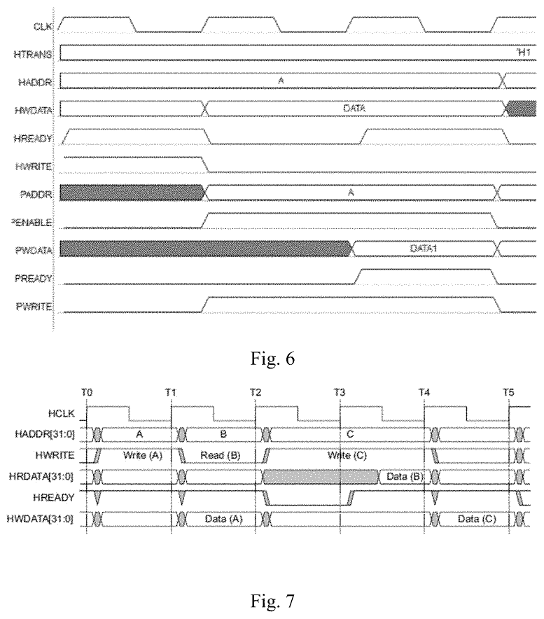

Specifically, transmission is divided into two phases according to a feature of the AHB: one is an address phase, and the other is a data phase. In the present embodiment, a current operation may include a read operation or a write operation. Referring to FIGS. 5 and 6, FIG. 5 is a timing diagram corresponding to an AHB-to-APB read operation, and FIG. 6 is a timing diagram corresponding to an AHB-to-APB write operation. In the address phase, for example, when HTRANS is 2′b01, and HREADY is valid (the level is high), HADDR is assigned to PADDR, HWRITE is assigned to PWRITE, and meanwhile, PENABLE is enabled. When a level of PREADY is high, PENABLE is recovered to a low level, and HWRITE is a write control signal (i.e., control information) of the AHB. When a level of HWRITE is high, the current operation is the write operation. When the level of HWRITE is low, the current operation is the read operation.

Specifically, when the current operation is the read operation, referring to FIG. 5, the address phase is in a first clock cycle only. In the data phase, when a level of a PREADY signal of the APB is high, and data is valid, namely a level of PSEL is high and a level of PENABLE is high, the data is fed back to HRDATA of the AHB.

Specifically, when the current operation is the write operation, referring to FIG. 6, an operation of the address phase is the same as the read operation. In the data phase, only when PREADY is valid, HWDATA of the AHB is directly assigned to PWDATA of the APB, and HREADY is made equal to PREADY.

Further, after the transmission is divided into the address phase and the data phase, which are identified with ahb_trans_head and ahb_trans_data respectively, wherein ahb_trans_head is a first identifier, and ahb_trans_data is a second identifier. When ahb_trans_head is valid, and ahb_trans_data is invalid, it is determined that the transmission is currently in the address phase. When ahb_trans_data is valid, and ahb_trans_head is invalid, it is determined that the transmission is currently in the data phase. The ahb_trans_head is valid under the condition that both HREADY and HTRANS are valid. The ahb_trans_data is valid at a next beat of ahb_trans_head. The ahb_trans_data becomes invalid when the level of HREADY is low and there is no ahb_trans_head, and is valid when levels of the above signals are all high. When ahb_trans_head and ahb_trans_data are both invalid, HREADY may be triggered to be converted to a high level. That is, the level of the HREADY is high by default, and HREADY is equal to PREADY in other cases.

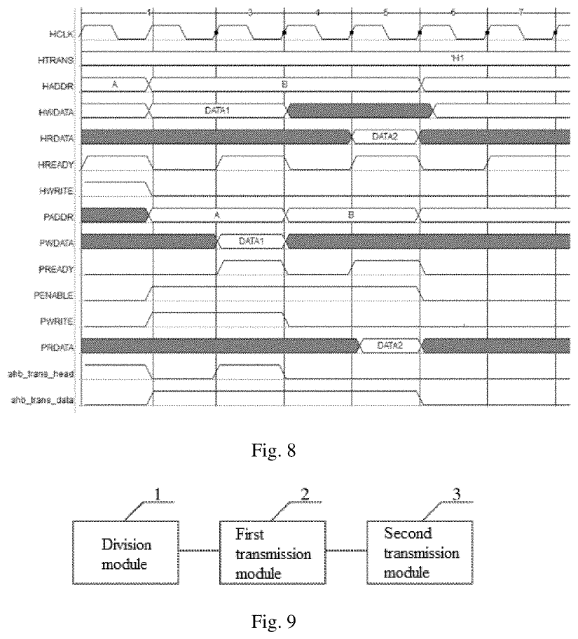

It can be understood that, during multi-transaction transmission shown in FIG. 7 on the AHB, a data phase of a current transaction is also an address phase of a next transaction, and bug occurs easily during transmission. Therefore, when ahb_trans_data and ahb_trans_head are both valid, namely in a third cycle in FIG. 8, the address phase is preferred in the present application. That is, HADDR is assigned to PADDR in the third cycle, so PADDR changes to address B in a fourth cycle. As such, address phases and data phases of transactions are distinguished.

The present application provides a data transmission method, applied to an APB bridge for connecting an APB and an AHB. A transmission process is divided into an address phase and a data phase first according to a feature of the AHB such that address information, control information, and data are transmitted in corresponding clock cycles respectively. In the present application, received information or data is transmitted when a condition corresponding to the current phase is met, whereby time for caching the address information, the control information, and the data is reduced, and the occupation of a storage space is thus reduced.

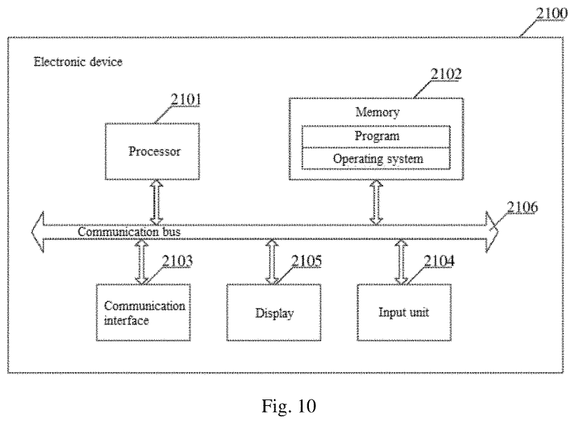

Referring to FIG. 9, FIG. 9 shows a data transmission apparatus provided in the present application, applied to an APB bridge for connecting an APB and an AHB, including:

a division module 1, configured to divide transmission into an address phase and a data phase according to a feature of the AHB;

a first transmission module 2, configured to, in the address phase, when the AHB meets an address transmission condition corresponding to a current operation, transmit address information and control information, which are sent by the AHB, to the APB; and

a second transmission module 3, configured to, in the data phase, when the APB meets a valid data transmission condition corresponding to the current operation, send received data to a bus corresponding to the current operation, wherein the bus is the APB or the AHB.

It can be seen that, according to the present embodiment, a transmission process is divided into an address phase and a data phase first according to a feature of the AHB such that address information, control information, and data are transmitted in corresponding clock cycles respectively. In the present application, received information or data is transmitted when a condition corresponding to a current phase is met, whereby time for caching the address information, the control information, and the data is reduced, and the occupation of a storage space is further reduced.

As a preferred embodiment, the data transmission apparatus further includes:

an identifier setting module, configured to set a first identifier corresponding to the address phase and a second identifier corresponding to the data phase; and

a phase judgment module, configured to judge whether the current transmission is in the address phase or the data phase according to whether the first identifier or the second identifier is valid.

As a preferred embodiment, the address transmission condition includes that HTRANS of the AHB is 2′b02, and HREADY of the AHB is valid.

As a preferred embodiment, the current operation includes a read operation or a write operation.

If the current operation is the read operation, the valid data transmission condition includes that:

levels of PREADY, PENABLE, and PSEL are all high.

If the current operation is the write operation, the valid data transmission condition includes that:

the level of PREADY is high.

As a preferred embodiment, the data transmission apparatus further includes:

an assignment module, configured to assign a value of PREADY to HREADY.

As a preferred embodiment, the phase judgment module is specifically configured to, when the first identifier and the second identifier are both valid, determine that the current transmission is in the address phase.

As a preferred embodiment, when HREADY and HTRANS are both valid, the first identifier is valid. It is determined that the second identifier is valid in a next clock cycle after the first identifier is valid.

As a preferred embodiment, the data transmission apparatus further includes:

a triggering module, configured to, when the first identifier and the second identifier are both invalid, trigger HREADY to be converted to a high level.

In another aspect, the present application also provides an electronic device. Referring to FIG. 10, a schematic composition structure diagram of an electronic device according to an embodiment of the present application is shown. The electronic device 2100 of the present embodiment may include a processor 2101 and a memory 2102.

Optionally, the electronic device may further include a communication interface 2103, an input unit 2104, a display 2105, and a communication bus 2106.

The processor 2101, the memory 2102, the communication interface 2103, the input unit 2104, and the display 2105 communicate with one another through the communication bus 2106.

In the embodiment of the present application, the processor 2101 may be a Central Processing Unit (CPU), an application specific integrated circuit, a digital signal processor, a field-programmable gate array or another programmable logic device, etc.

The processor may call a program stored in the memory 2102. Specifically, the processor may execute operations executed by an electronic device side in the following embodiment of a data transmission method.

The memory 2102 is configured to store one or more than one program. The program may include a program code that includes a computer operation instruction. In the embodiment of the present application, the memory at least stores programs for implementing the following functions:

dividing transmission into an address phase and a data phase according to a feature of an AHB;

in the address phase, when the AHB meets an address transmission condition corresponding to a current operation, transmitting address information and control information, which are sent by the AHB, to an APB; and

in the data phase, when the APB meets a valid data transmission condition corresponding to the current operation, sending received data to a bus corresponding to the current operation, wherein the bus is the APB or the AHB.

It can be seen that, according to the present embodiment, a transmission process is divided into an address phase and a data phase first according to a feature of the AHB such that address information, control information, and data are transmitted in corresponding clock cycles respectively. In the present application, received information or data is transmitted when a condition corresponding to a current phase is met, whereby time for caching the address information, the control information, and the data is reduced, and the occupation of a storage space is further reduced.

In a possible embodiment, the memory 2102 may include a program storage region and a data storage region. The program storage region may store an operating system, an application program needed by at least one function (such as a validity judgment function), etc. The data storage region may store data created according to use of a computer.

In addition, the memory 2102 may include a high-speed RAM, and may also include a nonvolatile memory, such as at least one disk memory device or other volatile solid-state memory device.

The communication interface 2103 may be an interface of a communication module, such as an interface of a Global System for Mobile communications (GSM) module.

The present application may further include the display 2104, the input unit 2105, etc.

Certainly, the structure of the electronic device shown in FIG. 10 does not form any limitation on the electronic device in the embodiment of the present application. In practical applications, the electronic device may include more or fewer components than those shown in FIG. 10, or some components are combined.

It is also to be noted that relational terms in the specification, such as first and second, are used only to distinguish an entity or operation from another entity or operation and do not necessarily require or imply the existence of any practical relation or sequence between these entities or operations. Moreover, terms “include” and “contain” or any other variation thereof is intended to cover nonexclusive inclusions, whereby a process, method, object, or device including a series of elements not only includes those elements but also includes other elements which are not clearly listed, or further includes elements intrinsic to the process, the method, the object, or the device. With no more restrictions, an element defined by statement “including a/an” does not exclude the existence of the same other elements in a process, method, object, or device including the element.

The disclosed embodiments are described above to enable those skilled in the art to implement or use the present application. Various modifications to these embodiments are apparent to those skilled in the art. The general principle defined herein may be implemented in other embodiments without departing from the spirit or scope of the present application. Therefore, the present application will not be limited to these embodiments shown herein but is consistent with the largest scope consistent with the principles and novel characteristics disclosed herein.

1. A data transmission method, applied to an Advanced Peripheral Bus (APB) bridge for connecting an APB and an Advanced High performance Bus (AHB), comprising:
dividing transmission into an address phase and a data phase according to a feature of the AHB;
in the address phase, in response to the AHB meeting an address transmission condition corresponding to a current operation, transmitting address information and control information, which are sent by the AHB, to the APB; and
in the data phase, in response to the APB meeting a valid data transmission condition corresponding to the current operation, sending received data to a bus corresponding to the current operation, wherein the bus is the APB or the AHB.

2. The data transmission method according to claim 1, wherein after the step of dividing transmission into the address phase and the data phase according to the feature of the AHB, the data transmission method further comprises:
setting a first identifier corresponding to the address phase and a second identifier corresponding to the data phase; and
judging whether a current transmission is in the address phase or the data phase according to whether the first identifier or the second identifier is valid.

3. The data transmission method according to claim 1, wherein the address transmission condition comprises that HTRANS of the AHB is 2′b02, and HREADY of the AHB is valid.

4. The data transmission method according to claim 1, wherein the current operation comprises a read operation or a write operation;
in response to the current operation being the read operation, the valid data transmission condition comprises that:
levels of PREADY, PENABLE, and PSEL are all high; and
in response to the current operation being the write operation, the valid data transmission condition comprises that:
the level of PREADY is high.

5. The data transmission method according to claim 1, wherein during the step of sending the received data to the bus corresponding to the current operation, the data transmission method further comprises:
assigning a value of PREADY to HREADY.

6. The data transmission method according to claim 2, wherein the method further comprises:
in response to the first identifier and the second identifier being both valid, determining that the current transmission is in the address phase.

7. The data transmission method according to claim 2, wherein the method further comprises:
in response to HREADY and HTRANS being both valid, determining that the first identifier is valid; and
determining that the second identifier is valid in a next clock cycle after the first identifier is valid.

8. The data transmission method according to claim 7, wherein the method further comprises:
in response to the first identifier and the second identifier being both invalid, triggering HREADY to be converted to a high level.

9. (canceled)

10. An electronic device, comprising:
a memory, configured to store a computer program; and
a processor, configured to execute the computer program to implement any steps of:
dividing transmission into an address phase and a data phase according to a feature of an Advanced High performance Bus (AHB);
in the address phase, in response to the AHB meeting an address transmission condition corresponding to a current operation, transmitting address information and control information, which are sent by the AHB, to an Advanced Peripheral Bus (APB); and
in the data phase, in response to the APB meeting a valid data transmission condition corresponding to the current operation, sending received data to a bus corresponding to the current operation, wherein the bus is the APB or the AHB.

11. The data transmission method according to claim 1, wherein under a circumstance that HTRANS is 2′b01 and HREADY is valid with a high level, HADDR is assigned to PADDR, HWRITE is assigned to PWRITE, and meanwhile, PENABLE is enabled.

12. The data transmission method according to claim 1, wherein under a circumstance that a level of PREADY is high, PENABLE is recovered to a low level, and HWRITE is a write control signal.

13. The data transmission method according to claim 1, wherein under a circumstance that a level of HWRITE is high, the current operation is a write operation.

14. The data transmission method according to claim 1, wherein under a circumstance that a level of HWRITE is low, the current operation is a read operation.

15. The data transmission method according to claim 2, wherein under a circumstance that ahb_trans_head is valid and ahb_trans_data is invalid, the transmission is currently determined as in the address phase.

16. The data transmission method according to claim 2, wherein under a circumstance that ahb_trans_data is valid and ahb_trans_head is invalid, the transmission is currently determined as in the data phase.

17. The data transmission method according to claim 2, wherein under a circumstance that a level of HREADY is low and there is no ahb_trans_head, ahb_trans_data becomes invalid.

18. The data transmission method according to claim 2, wherein under a circumstance that levels of HREADY and ahb_trans_head are all high, ahb_trans_data becomes valid.

19. The data transmission method according to claim 2, wherein under a circumstance that ahb_trans_data and ahb_trans_head are both valid, the address phase is preferred.

20. The data transmission method according to claim 1, wherein during multi-transaction transmission, the data phase of a current transaction is the address phase of a next transaction, and bug occurs.

21. The electronic device according to claim 10, wherein the processor is configured to execute the computer program to implement any steps of:
setting a first identifier corresponding to the address phase and a second identifier corresponding to the data phase; and
judging whether a current transmission is in the address phase or the data phase according to whether the first identifier or the second identifier is valid.
